(19) United States
(12) Patent Application Publication
(10) Pub. No.: US 2022/0086081 A1
(43) Pub. Date: Mar. 17, 2022

(54) SYSTEMS AND METHODS FOR CONTAINERIZATION OF ROUTER PROCESSES

(71) Applicant: CenturyLink Intellectual Property LLC, Broomfield, CO (US)

(72) Inventor: Noah Kipling Weis, Denver, CO (US)

(73) Assignee: CenturyLink Intellectual Property LLC, Broomfield, CO (US)

(21) Appl. No.: 17/156,436

(22) Filed: Jan. 22, 2021

Related U.S. Application Data
(60) Provisional application No. 63/078,776, filed on Sep. 15, 2020.

(51) Int. Cl. H04L 12/703; H04L 12/715; H04L 12/707; H04L 12/24

(52) U.S. Cl. CPC H04L 45/28; H04L 41/082; H04L 45/22; H04L 45/04

(57) ABSTRACT

A routing system can provide containerized router processes. The routing system can execute one or more router processes, e.g., the Border Gateway Protocol, the Access Control List, etc., in containers. Thus, the router processes can be upgraded, fail, etc. without affecting other router processes or the overall function of the router. When a router process is unavailable, requesting services may send messages to the container but may receive no response. To determine the availability of the router process, the requesting service may then request the status of the router process from a state database (statedb). The statedb can be a data store and interface that stores and reports the status of containers within the router. The statedb can reply to the requesting service as to whether the router process is available and/or with other information.

### FIELD

The present disclosure is generally directed to networking.

### BACKGROUND

Communications between electronic devices (e.g., desktop computers, mobile devices, laptops, etc.) can occur through a network, for example, the Internet. Within the network, a group of interconnected routers can pass messages from the source or originating device, over one or more hops between the routers, to the destination or terminating device. Routers have various processes that execute to perform the functionality of the router. These processes can become unavailable because the processes fail or require downtime for updates to the software that provides the functionality. When these processes are unavailable, the entire router may be unavailable. Thus, when a process in the router is updated, the entire functionality of the router may be affected. These outages affect the user's experience with the network, can slow the movement of network traffic, and may cause the loss of data.

### BRIEF DESCRIPTION OF THE DRAWINGS

FIG. 1 depicts a communication environment in accordance with examples of the present disclosure;

FIG. 2 depicts an example of a routing system in accordance with examples of the present disclosure;

FIG. 3 depicts a software architecture in accordance with examples of the present disclosure;

FIG. 4 depicts a signaling process in accordance with examples of the present disclosure;

FIG. 5A depicts a data structure that can be sent, received, stored, retrieved, etc., in accordance with examples of the present disclosure;

FIG. 5B depicts a data structure that can be sent, received, stored, retrieved, etc., in accordance with examples of the present disclosure;

FIG. 5C depicts a data structure that can be sent, received, stored, retrieved, etc., in accordance with examples of the present disclosure;

FIG. 5D depicts a data structure that can be sent, received, stored, retrieved, etc., in accordance with examples of the present disclosure;

FIG. 6 depicts a method for providing containers for router processes in accordance with examples of the present disclosure;

FIG. 7 depicts a method for determining a router process is unavailable in accordance with examples of the present disclosure.

### DETAILED DESCRIPTION

The present disclosure provides for a router with containerized router processes. In an example, a control component of a routing system can execute one or more router processes, e.g., the Border Gateway Protocol, the Access Control List, etc. These router processes are executed as or in a container. Thus, the router processes can be upgraded, fail, etc. without affecting other router processes or the overall function of the router. When a router process is unavailable, requesting services may send messages to the container but may receive no response. To determine the availability of the router process, the requesting service may then request the status of the router process from a state database (statedb). The statedb can be a data store and interface that stores and reports the status of containers executed within the router. The statedb can reply to the requesting service as to whether the router process is available and/or other information. Even with the router process unavailable, the router can still execute other processes and may still be functional to route network traffic.

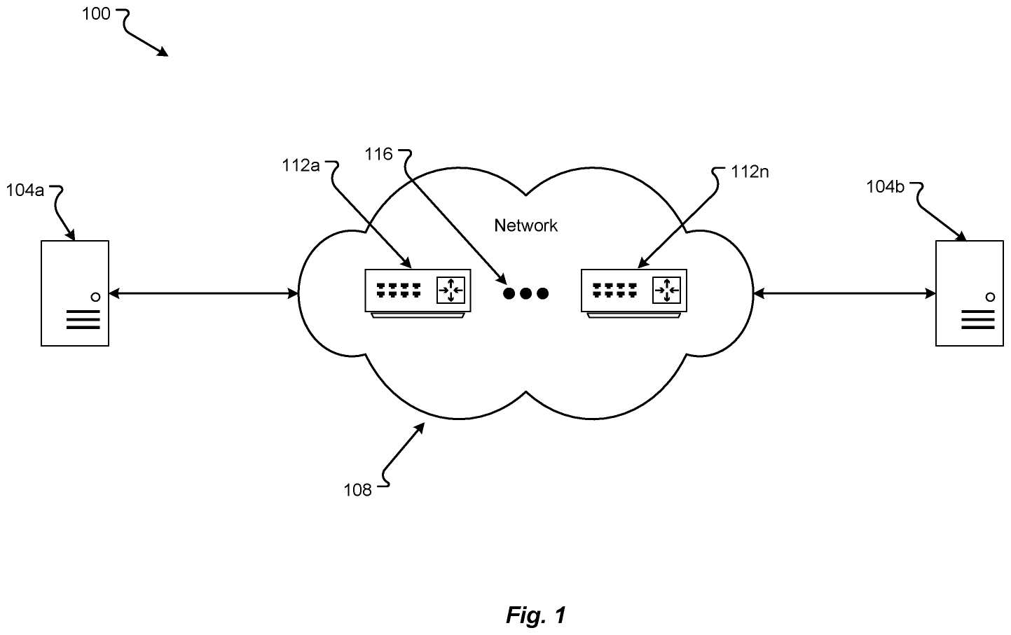

An example of a communication environment 100 for routing communications is shown in FIG. 1. The communication environment 100 can include a source device 104a and a destination device 104b (devices 104a and 104b, along with any similar devices, may be referred to collectively herein as devices 104). The devices 104 can be any type of device capable of communicating through the communication environment 100. For example, the devices 104 can be mobile devices, desktop computers, laptops, servers, memory, storage systems or repositories, or other types of devices or systems.

The devices 104 communicate through a network 108. The network 108 can represent any type of local, distant, wireless, or other type of network. For example, the network 108 may represent one or more of a local area network (LAN), a wide area network (WAN), a wireless LAN (WLAN), the Internet, etc. Further, the network 108 can represent a combination of two or more of the aforementioned network types or other types of networks.

The network 108 can be composed of one or more routing systems 112a through 112n (routing systems 112a through 112n may be collectively referred to herein as routing systems 112). There may be more or fewer routing systems 112 than those shown in FIG. 1, as represented by the ellipses 116. A routing system 112 can receive a communication that was originated from the source device 104a (and that may have been forwarded by one or more previous routing systems 112) and is to be routed to a destination device 104b. These communications may need to be routed or travel through one or more the routing systems 112 before reaching the destination device 104b, and, as such, each routing system 112 is operable to route the communications between and among the other routing systems 112 to reach the destination device 104b.

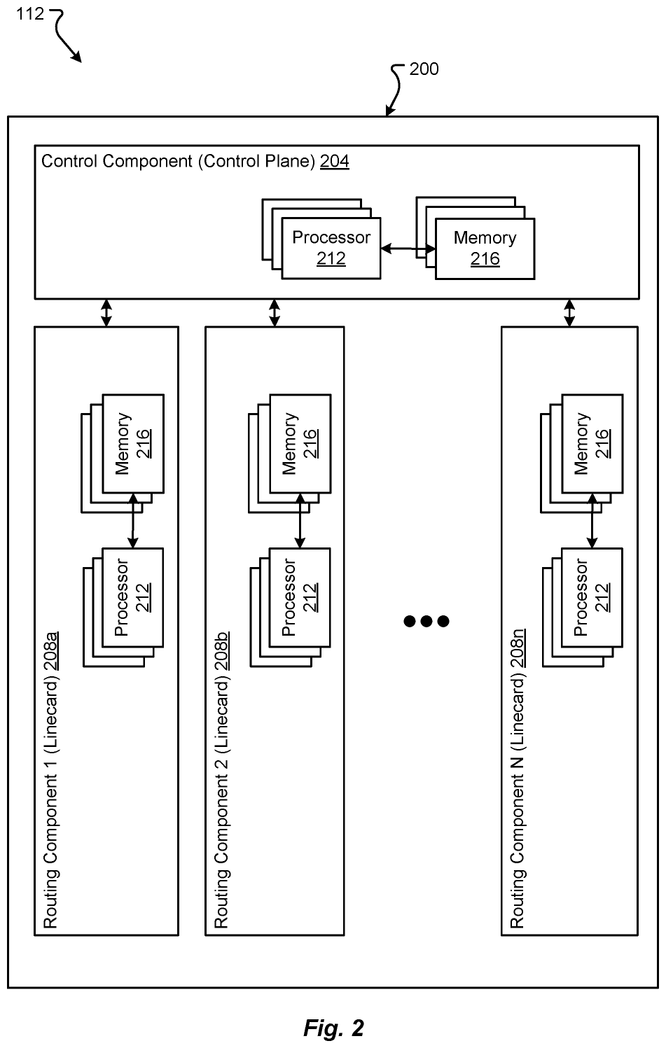

An example routing system 112 may be shown as in FIG. 2. The routing system 112 may be a physically separate device, such as a router 200. In other configurations, the routing system 112 may be formed from several physically separate devices that may not be part of a single router or singular routing system 112. The different routing systems 112 may have similar components, elements, or devices that perform similar functions. As such, various configurations of the routing systems 112 may be as explained hereinafter.

The routing system 112 can comprise one or more hardware elements that may be communicatively or electrically coupled, for example, via a control component 204. The control component 204 can be a control plane 204, as shown in FIG. 2, a control device, or some other type of control component 204; the “control component 204” can refer to any of these or other configurations. In at least some configurations, the control component 204 may comprise one or more processors 212 and associated memory 216. In examples, each control component 204 can include two or more processors 212 that can each be considered a separate control component 204 (along with associated memory 216). Regardless, the control component 204 may provide information or other data to one or more routing components 208a through 208n (routing components 208a through 208n may be referred to herein as routing components 208). Further, the control component 204 may control at least some of the operations of the routing components 208.

The routing system 112, whether a router 200, as shown in FIG. 2, or separate devices, can include one or more routing components 208a through 208n. The routing components 208 can be linecards, as shown in FIG. 2, physically separate devices, or some other configuration of components. “Routing component 208” can refer to any of the above and other configurations. As with the control component 204, in at least some configurations, the routing component 208 may comprise a processor 212 and associate memory 216. As such, each routing component 208 (e.g., each routing linecard or device) can include two or more processors 212 and associated memory 216.

Each routing component 208 may control the routing or distribution of communication signals entering and leaving the routing system 112. For example, the routing component 208 may receive a communication at a first port, for example, at the router 200, and may route that communication to a destination device 104b or to another routing system 112, through a second port. Both the control component 204 and the routing component 208 can contain one or more hardware components to either control the routing component 208 or to route the communications.

The hardware components may include one or more of, but is not limited to, one or more processors 212, one or more input interfaces, one or more output interfaces, and one or more memory components 216. Examples of the processors 212 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core® family of processors, the Intel® Xeon® family of processors, the Intel® Atom® family of processors, the Intel Itanium® family of processors, Intel® Core® i5-4670K and i7-4770K 22 nm Haswell, Intel® Core® i5-3570K 22 nm Ivy Bridge, the AMD® FX® family of processors, AMD® FX-4300, FX-6300, and FX-8350 32 nm Vishera, AMD® Kaveri processors, Texas Instruments® Jacinto C6000® automotive infotainment processors, Texas Instruments® OMAP® automotive-grade mobile processors, ARM® Cortex®-M processors, ARM®. Cortex-A and ARM926EJ-S® processors, other industry-equivalent processors, and may perform computational functions using any known or future-developed standard, instruction set, libraries, and/or architecture. The processors 212 can also include one or more of, but are not limited to, application specific integrated circuits (ASIC), field programmable gate arrays (FPGA), other central processing units, a system-on-chip (SOC), or other types of processors.

The memory components 216 may be disk drives, optical storage devices, solid-state storage devices, such as a random access memory (“RAM”) and/or a read-only memory (“ROM”), which can be programmable, flash-updateable, and/or the like. However, in at least some configurations, the memory components are ternary content addressable memory/reduced latency dynamic random access memory (TCAM/RLDRAM) that are capable of reduce latency, high-speed switching to provide high-speed access to the data stored within the memory. Additionally or alternatively, each control component 204 and routing component 208 may have two or more processors 212, each with dedicated memory 216. In these configurations, each separate processor 212 with its associated memory 216 may be considered a separate routing component 208 although physically contained on a same linecard or other physical substructure with other processors 212.

The routing system 112 may also comprise software components, located within a working memory 216, including an operating system and/or other code. It should be appreciated that alternate examples of a routing system 112 may have numerous variations from that described above. For example, customized hardware might also be used and/or particular components might be implemented in hardware (e.g., ASIC gates), software (including portable software, such as applets), or both hardware and software. Further, connection to other computing devices, such as network input/output devices, may also be employed to conduct at least one function of the software as described hereinafter.

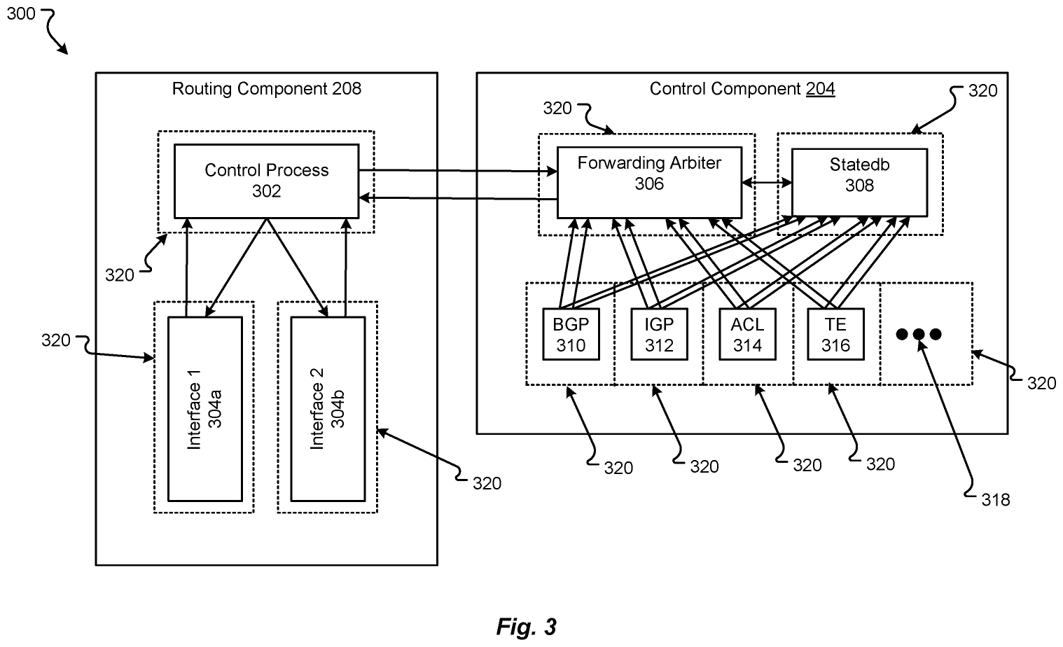

An example of a software architecture 300 of a routing system 112 may be as shown in FIG. 3. While the following is described as software, in at least some configurations, the software architecture 300 may be embodied as gates or circuits in an ASIC, FPGA, or other hardware device. The software architecture 300 can include one or more applications, stored in working memory 216, and executed by the processor 212, and one or more data structures stored in and accessed from memory 216.

A routing component 208 can include processes executed by a processor 212 of the routing component 208. The routing processes, executed by the processor 212, can include a control process 302 and one or more interface processes 304, e.g., interface 304a and interface 304b. Control process 302 can control the routing of data through the routing component 208 to the interfaces 304. The control process 302 can ensure data is routed to the proper interface 304 received from interface 304, managed properly within the routing system 112, and sent to the proper interface 304 for transmission out of the routing system 112.

The interfaces 304 can be the software and/or hardware interface that sends data out or receives data into the routing system 112. The interfaces 304 can include any type of filters, data transformations, packetizing, data manipulation, or other types of processes used to both receive and send data across different types of communication networks and by different communication protocols. These communication interfaces 304 can include interfaces to LANs, wLANs, WANs, the Internet backbone, etc. The interfaces 304 can condition the data and may transmit or receive data over those different networks.

The control component 204 can also execute one or more processes used in the routing of data. The routing process in the control component 204 can include one or more of, but is not limited to, the forwarding arbiter 306, the statedb 308, other security, bandwidth management, and other types of processes. For example, the other processes executed by the control component 204 can include the border gateway protocol (BGP) 310, the interior gateway protocol (IGP) 312, the access control list (ACL) 314, traffic engineering (TE) 316, etc. These specific processes are only exemplary, and there may be more or fewer processes executed within the control component 204, as represented by ellipses 318.

The various processes above and the other processes described herein can be encapsulated in containers. For example, the different processes 310 through 316 may each be formed or encapsulated in a separate software container. This containerization of these different processes is represented by boxes 320. The other components, either in the routing component 208 (e.g., the control process 302, the interface 304, etc.) or the control component 204 (e.g., the forwarding arbiter 306, the statedb 308, etc.), can also be provided in containers 320. It should be noted that “container 320” may be used to refer generally to any container that may be provided in system 300, regardless of whether that container is associated with processes 310-316 or provided in routing component 208 or control component 204. It should be noted that the container 320 allows for the process in the container 320 to operate independently of other containers 320. Further, the container 320 also allows for continuous deployment of the process regardless of the state of other containers 320.

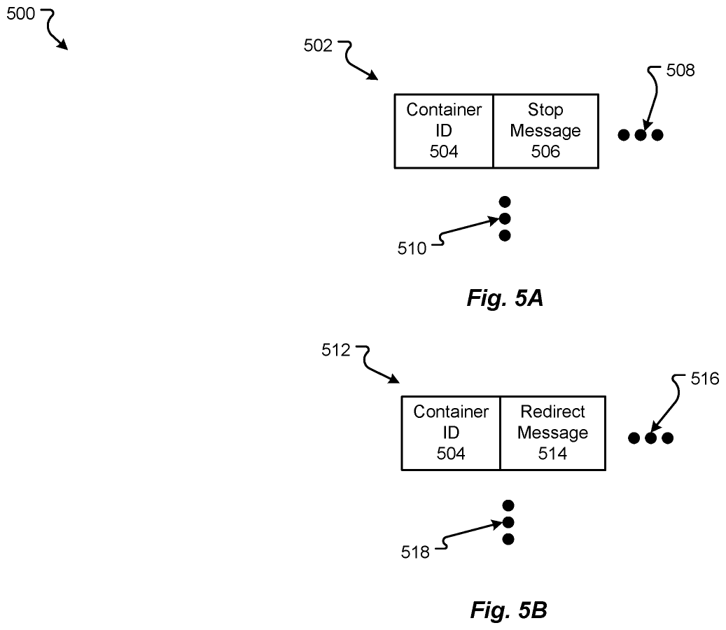

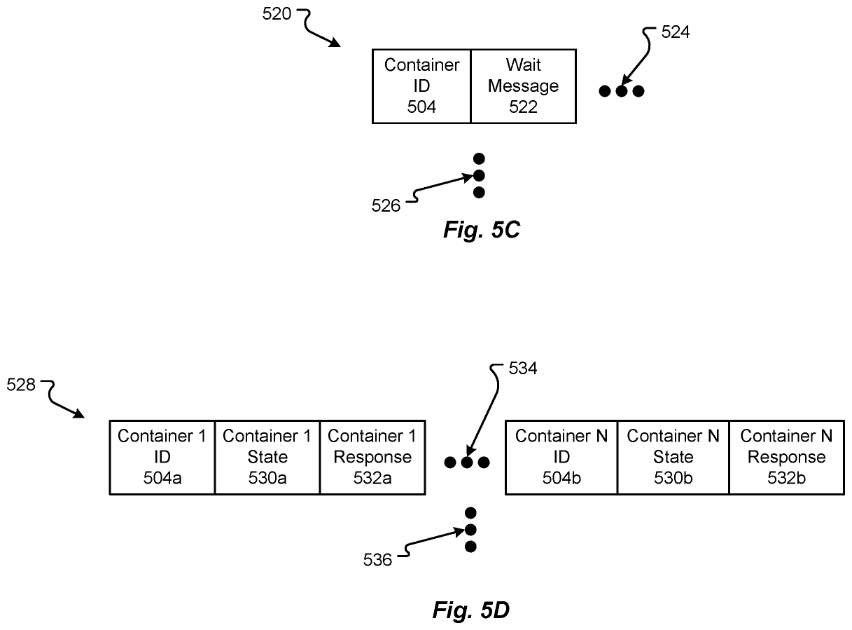

Control component 204 can execute the statedb 308 that can store and provide the state of the various containers to the other components. The statedb 308 can include any type of data store and/or interface to provide state data about one or more of the containers within the system 300. The statedb 308 can receive state messages from one or more of the processes associated with system 300 and store that state information. Other components may request knowledge of the different states of different processes, and the statedb 308 can reply with the state. The state data may be as provided in data structure 528, as described in conjunction with FIG. 5D. The different messages sent to the statedb 308, to change the state of the process within the statedb 308, may be as shown in data structure 502, described in conjunction with FIG. 5A. Further, the message data structure 512 sent from the container 320, to redirect requests to the statedb 308, may be as shown in FIG. 5B. Finally, the message data structure 520 sent by the statedb 308, in response to requests by other components about a state of a process in a container, may be as shown in data structure 520 provided in FIG. 5C.

The forwarding arbiter 306 forwards instructions or requests for different types of processes from, for example, the control process 302 to the different processes 310-316. The forwarding arbiter 306 thus acts as a switch or routing component that routes different requests and other information between the processes 310 through 316 and the control process 302 or between other routing processes. As such, the forwarding arbiter 306 is connected to each of the different processes 310 through 316 and may act as an intermediary to control communications thereto. It should be noted that forwarding information used by the forwarding arbiter 306 does not change frequently. Thus, changes in the forwarding data does not generally affect routing of data by the routing system 112. Rather, changes to the routing processes 310-316 are a much greater source of issues with uptime and routing data reliably.

Example routing processes are provided in the software architecture 300 of the routing system 112, for example, the BGP 310, which implement different protocols or different types methods used to control or change the routing of the routing component 208. For example, the BGP 310 is an exterior gateway protocol that is used to exchange routing and other information among different routing systems 112 or other systems on the network, e.g., the Internet. The information can include different paths, network policies, or other rules that may either be configured by administrators or used by the network to send information. Similarly, the IGP 312 is a protocol used to exchange information between routers within a network. Thus, IGP 312 can provide similar types of information as the BGP 310 but provides that information or performs processes for the intranetwork routing between routers of the same network.

The access control list 314 is a process that provides permissions for accessing objects, or other types of information, data, systems, etc. within the network. The ACL 314 controls access for which users or systems are allowed or granted access to different objects within the system. As such, the ACL 314 can determine permissions for the different users sending data through the routing component 208.

Traffic engineering (TE) 316 can include any of the processes that are used to efficiently steer traffic between routing components 208. The TE 316 process ensures the best, most efficient use of bandwidth between routers in the system. Thus, TE 316 can change which interfaces 304 are used or which data is sent along which pathways to manage bandwidth efficiently.

The container box 320 is exemplary and does not necessarily include all processes or the only processes that may be provided by the control component 204 or routing component 208 in a container 320. Further, one or more of the processes shown in box 320 may not be provided by the control component 204. Regardless, the boxes 320 represent the containers that encapsulate the routing processes 310-316 or any other containerized application.

The processes that provide the different functions of the routing component 208 and/or control component 204 can be provided in a software container. The container allows for the software to be wholly contained and allows the contained application to stop functioning, go down, and be improved, etc., without necessarily affecting other parts of the system 300. In this way, the various components 204, 208 need not be taken down to change, alter, restart, etc. one application or process provided in a single container. Rather, the unavailable process in the container can be fixed while other components are still operating.

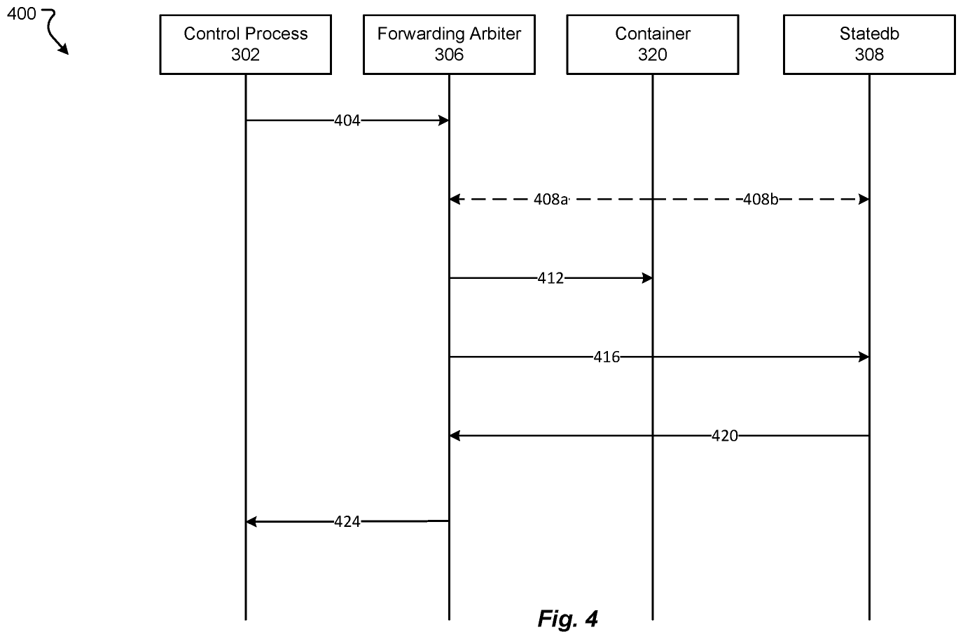

An example of the routing or communications between the various components of the system 300 may be as shown in FIG. 4. This communication environment 400 may include communications to and from the control process 302, the forwarding arbiter 306, one or more containers 320, and the statedb 308, over various different interfaces or using various communication protocols. The signaling processes, in the communication environment 400, herein are exemplary and show a possible exchange of messages that may occur, based on a container 320 being unavailable. In a first communication message 404, the control process 302 can request access to a routing process, e.g., processes 310-316, contained in a container 320. The request message 404 may be sent to the forwarding arbiter 306. This message 404 may request access to the process from the forwarding arbiter 306.

At some time before or after message 404 is sent, container 320 may optionally send one or more messages 408 (e.g., message 408a and message 408b) to one or more other processes, e.g., the forwarding arbiter 306, the statedb 308, etc. This message 408 can indicate that the container 320 is not going to be unavailable or is not available for some reason. For example, if the software in the container 320 is being updated, the container 320 may be unavailable during the upgrade. Thus, the container 320 can send an optional message 408 indicating that the routing processes associated with the container 320 will be unavailable during this upgrade. The “redirect message” 408a may be the same or similar to message 512, described in conjunction with FIG. 5B. The “stop message” 408b may be the same or similar to message 502, described in conjunction with FIG. 5A

In other situations, the container 320 may be inadvertently unavailable, caused by an error or fault in the software or for some other reason. In this situation, optional message 408 is not sent; however, the state of the container may still change in the statedb 308 because the statedb 308 may receive information or may be able to determine that the state of the container 320 has changed. For example, the statedb 308 may poll the containers 320, may determine whether the amount of time, since a message or communication has been sent from the container 320, crosses a threshold, may receive information from a first process that indicates a second process is unavailable, etc. The messages sent between processes may be sent and received on a bus to which the statedb 308 monitors. Thus, the statedb 308 can continuously monitor the bus for information about the state of one or more containers 320.

The forwarding arbiter 306 may then send a message 412, which can forward the instruction related to message 404. The message 412 can request a process encapsulated by the container 320. The forwarding arbiter 306 may then wait for the process to provide some functionality and/or a response. If the process times out and the forwarding arbiter 306 does not receive a response to message 408, the forwarding arbiter 306 may then send another instruction to the statedb 308 as message 416. The message 416 may request the state of the process in container 320 that was sent message 412. Statedb 308 can respond to this message, in message 420. The response message 420 may be a wait message 520, as described in conjunction with FIG. 5B. The wait message 420 may allow the forwarding arbiter 306 to determine that the process is unavailable. This information, in message 420, from the statedb 308 may then be passed back to the control process 302 through message 424. The control process 302 may then determine how to respond to the unavailability of the process, including forgoing the process and continuing to forward data or to wait for the process.

The data structures 500 that may be stored in memory 216, communicated between components 302-320, or read by the components 302-320 may be as shown in FIGS. 5A through 5D. An example of a stop message data structure 502, for example, message 408b, may be as shown in FIG. 5A. The stop message data structure 502 indicates that the control process 302 and the container 320 that contains the control process 302 is not or will no longer function for some period of time. The stop message data structure 502 may contain one or more of, but is not limited to, a container identifier (ID) 504 and a stop message 506. There may be more or fewer fields than those described in conjunction with FIG. 5A, as represented by ellipses 508. Further, for each time a process stops or is unavailable, a different stop message data structure 502 may be sent, as represented by ellipses 510.

The container ID 504 can include any type of identifier for the container 320. For example, the container ID 504 can be an alphanumeric identifier, a numeric identifier, a globally unique identifier (GUID), or another type of identifier. The container ID 504 identifies the container 320 uniquely amongst the other containers within the system 300 or routing system 112.

The stop message 506 is information indicating that the process or software contained within the container 320, is no longer or will no longer function for a period of time. The stop message 506 can indicate that the process will be unavailable and can also include other information, for example, when the process will stop operating, when the process is expected to return, the reasons for the stop (e.g., for a software upgrade, for other types of maintenance, etc.), or other information. The information in the stop message 506 may be stored, with the state, in the statedb 308. Further, receiving the stop message data structure 502 indicates to the statedb 308 that the state of the process, in the container 320, has changed, and thus, the statedb 308 may need to report the change in state to one or more other processes.

Each different container 320 and process contained therein can have a different stop message 506. Each of these different stop message 506 can have a different resolution to mitigate the unavailability of the container. For example, if an interface 304a, 304b is unavailable, the stop message 506 from the container 320 that contains the interface 304 may state that the interface is down and that data is non-routable through the interface 304. This stop message 506 can inform the control process 302 to move or redirect data to another interface 304, if possible. In another example, the control process 302 may be unavailable. The stop message 506 from the control process 302 may state that internet pass-through is unavailable and/or that the control process 302 is experiencing an error. The stop message 506 may suggest traffic backoff to mitigate the problem. In an example with the forwarding arbiter 306 being unavailable, the stop message data structure 512 may state that the forwarding arbiter 306 is available for receive only. In a final example, the routing process 310-316 may be unavailable. The container 320 may send a stop message data structure 512 that directs the forwarding arbiter 306 to check with the statedb 308 until the process is available again.

An example of a redirect message data structure 512 may be as shown in FIG. 5B. The redirect message data structure 512 may be sent by an unavailable container or other process to indicate the unavailable process cannot execute and the requester should redirect requests to the statedb 308. The redirect message data structure 512 data structure can include one or more of, but is not limited to, a container ID 504 and a redirect message 514. The redirect message data structure 512 can have more or fewer field in the data structure 512, as represented by ellipses 516. For each request of a stopped process, the unavailable process or other process may send a different redirect message data structure 512, as represented by the ellipses 518. The container ID 504 may be the same or similar to the container ID 504, as described in conjunction with FIG. 5A. As such, the container ID 504 will not be explained further here.

The redirect message 514 can include any information required by a process requesting functionality from an unavailable process. For example, the redirect message 514 can include the state of the unavailable process, how long the process will be stopped, what types of actions the requester should take to mitigate the unavailability of the process, etc. In a least some configurations, the redirect message 514 redirects requests to the statedb 308. The redirect message data structure 512 may be sent, for example, by an interface, to the container 320, which is maintained while the process in the container 320 is unavailable. In other circumstances, another process or interface may be created or directed to intercept requests to the unavailable process and send the redirect message data structure 512 when the process is unavailable.

An example of a wait message data structure 520 may be as shown in FIG. 5C. The wait message data structure 520 may be sent by the statedb 308 when a request for a process, which is unavailable, is received by the statedb 308. The wait message data structure 520 can include one or more of, but is not limited to, the container ID 504 and a wait message 522. There may be more or fewer fields than that shown in FIG. 5C, as represented by ellipses 524. For each time a routing process is stopped and the statedb 308 may provide state information to another process, a new wait message data structure 520 may be sent, as represented by ellipses 526. The container ID 504 may be the same or similar to container ID 504, as described in conjunction with FIG. 5A, and will not be explained further here.

The wait message 522 can be any information required to provide the state of the unavailable process. For example, the wait message 522 can include an indication that the state of the requested process is unavailable, the amount of time that the unavailable process may be unavailable, a time at which the unavailable process is expected to return, how to mitigate the unavailability of the process, etc. As the forwarding arbiter 306 is most likely to request the state, this wait information, in the wait message 522, may be forwarded to the forwarding arbiter 306, which may then forward that information to the control process 302 or other process.

An example of a data structure 528 that stores the state of different processes or containers, within the system 300, may be as shown in FIG. 5D. The data structure 528 can record the states in real-time or near real-time as those states dynamically change. The statedb 308 may create and maintain this data structure 528. The data structure 528 can include one or more sets of, but not is not limited to, the following: a container ID 504, a container state 530, and container response 532, which are related to a predetermined container 320. For example, a first container, container 1, can be associated with a container 1 ID 504a, a container 1 container state 530a, and a container 1 response 532a. Each container may have a set of such data. Thus, there may be a set of data for container 1 through container N. Container N can be associated with the container N ID 504b, the container N container state 530b, and the container N response 532b. There may be more or fewer sets of the data for the different containers 320, as represented by ellipses 534. For each system or set of containers 320, there may be another set of state data, as represented by ellipses 536. The container ID 504a or container ID 504b may be the same or similar to the container ID 504, as described in conjunction FIG. 5A and thus, will not be explained further here.

The container state 530 can be a state of the container 320. The container state 530 can either be operational or unavailable, for example. The state 530 can also include other information, for example, the reason(s) why the container is unavailable at the current time. Further, the state 530 can include the amount of time expected for the container 320 to be unresponsive or unavailable, may include a start time and/or stop time of unavailability, and/or may include other information.

The container response 532 can include what information may be used by the statedb 308 to respond to request for the processes state. This response information 532 can include the redirect message data structure 512 or the wait message data structure 520, as described in conjunction with FIGS. 5B and 5C, respectively. The response 532 can also include other information, for example, how to mitigate the unavailability of this process, how the unavailability of the process may affect the routing of data, or other information.

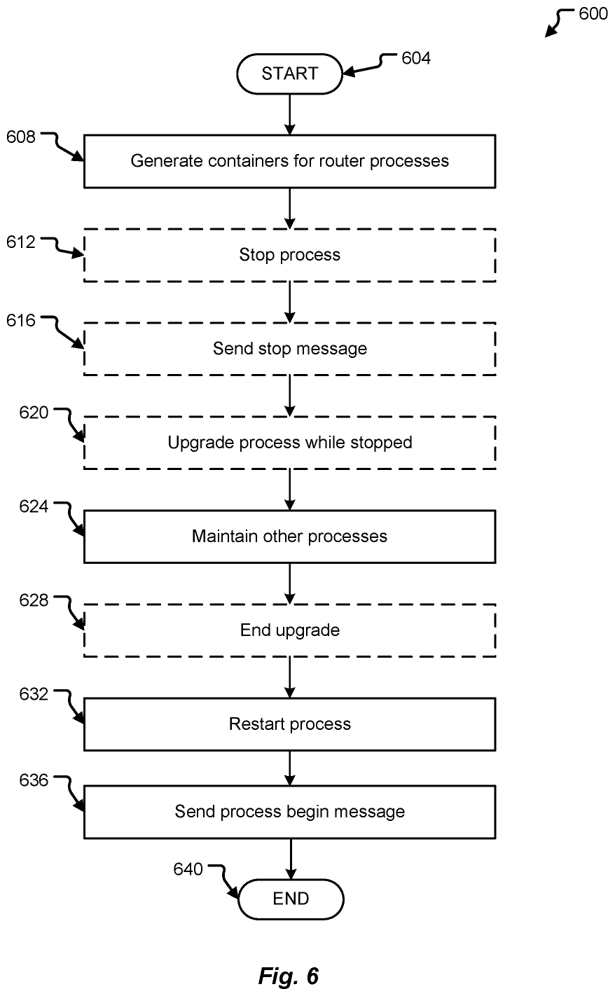

An example of a method 600 for dealing with the unavailability of the process in a container 320 may be as shown in FIG. 6. A general order for the operations of the method 600 is shown in FIG. 6. Generally, the method 600 starts with a start operation 604 and ends with an end operation 640. The method 600 can include more or fewer operations or can arrange the order of the operations differently than those shown in FIG. 6. The method 600 can be executed as a set of computer-executable instructions executed by a processor, such as processor 212 of the control component 204, and encoded or stored on a computer readable medium. Further, the method 600 can be performed by gates or circuits associated with a processor, an ASIC, a FPGA, a SOC, or other hardware device. Hereinafter, the method 600 shall be explained with reference to the systems, components, devices, modules, software, signals, data structures, interfaces, methods, etc. described in conjunction with FIGS. 1-5D and 7; however, it will be understood by those of skill in the art that some or all of the operations of method 600 can be performed by or using different elements from those described below.

The system 300 generates containers for the router processes, in operation 608. The containers may be created by a software executed by one or more of the processors 212 of the routing system 112. For example, the containers 320 may be built using a software, for example, DOCKER, provided by Docker, Inc., or Cloud Build, or other software. The containers 320 are an abstraction of the software that packages or encapsulates the code so that the application can execute in one or more computing environments, is independent, is portable between computing environments, and/or does not affect other functionality when unavailable. Further, the statedb 308 may also be developed and deployed, in operation 608.

The statedb 308 can create the data structure 528 that contains the state of the various containers 320 within the system 300. Thus, the statedb 308 can either create or receive the container ID 504 for the containers and optionally, any response information 532 from the various containers 320. This state and response information may then be stored in the data structure 528, by the statedb 308, for the statedb 308 to access later.

Steps 612, 616, and 620 may be optional. These steps 612, 616, and 620 may occur when the software in the container is purposely paused or made unavailable to upgrade or maintain the process in the container 320. The steps 612, 616, and 620 are not likely to occur if the process may suffer an error where the state of the container 320 changes by error or fault. In these situations, the system 300 may still be able to execute the other routing process and functions without executing the unavailable container 320.

In operation 612, the process or the application stops executing in the contain 320. The stop in processing may be due to user intervention or for other reasons. For example, the application that performs the process may be undergoing an upgrade, which is written when the application stops executing to install new code. Thus, to do the upgrade, the upgrading process may request a process in the container 320 to send a stop message data structure 502 to indicate the process will be unavailable. A stop message data structure 502 can trigger a recalculation for forwarding data and/or can trigger other processes to consult the statedb 308 about the state of the unavailable process.

The container 320 may then send a stop message data structure 502 to one or more other components. For example, the container 320 may send the stop message data structure 502 to the forwarding arbiter 306, the statedb 308, or other processes. In some implementations, the container 320 may also cause any processes that either send information, data, or signals to the container 320, or that receive information, data, signals, or messages from the container 320 to pause interaction with the unavailable process. The pause of these “adjacent” components instructs or informs those adjacent process to not change function, data, messaging, etc. until the unavailable process returns to normal operation. The stop message data structure 502 may be received by the statedb 308, in operation 620. Based on the stop message data structure 502 being received, the statedb 308 may change the state of the container 320 in data structure 528, changing the state information in container state field 530. This change in state may be reported to the statedb 308 and/or from the statedb 308 to other components.

Also, in operation 620, the software, within the container 320, can be upgraded, while the container 320 is unavailable. The upgrade may take some amount of time and any information about the upgrade process may also be provided to the statedb 308. Thus, the statedb 308a can save information about the upgrade into the container response 532. In this way, the statedb 308 may be able to provide the information to inform requesters about how long the wait for the upgrade may be and how long it will be until the process in the container 320 will be available.

The software architecture 300 of the routing system 112 maintains other processes during this upgrade, in operation 624. With the container 320 encapsulating the process under the upgrade, only the one container 320 maybe affected by the upgrade. As such, the software architecture 300 of the routing system 112 can maintain its ability to forward data and function for other processes.

The container 320 and the software therein may finish the upgrade, in optional step 628. If an upgrade was occurring in the optional steps above, that upgrade can end at some period after the process started the upgrade. This second change in state may then be reported to the statedb 308, which then changes the container state 530 within data structure 528. The process may be restarted, in operation 632. The container 320 can restart after the upgrade or after a failure and a begin message may then be sent to the statedb 308 or to the other processor components therein, in operation 636. For example, the adjacent processes that send or receive data from the previously unavailable process may be unpaused so that those communications can resume. Other processes requiring or requesting the process in the container 320 may also be informed of the change of the state to request services from that process.

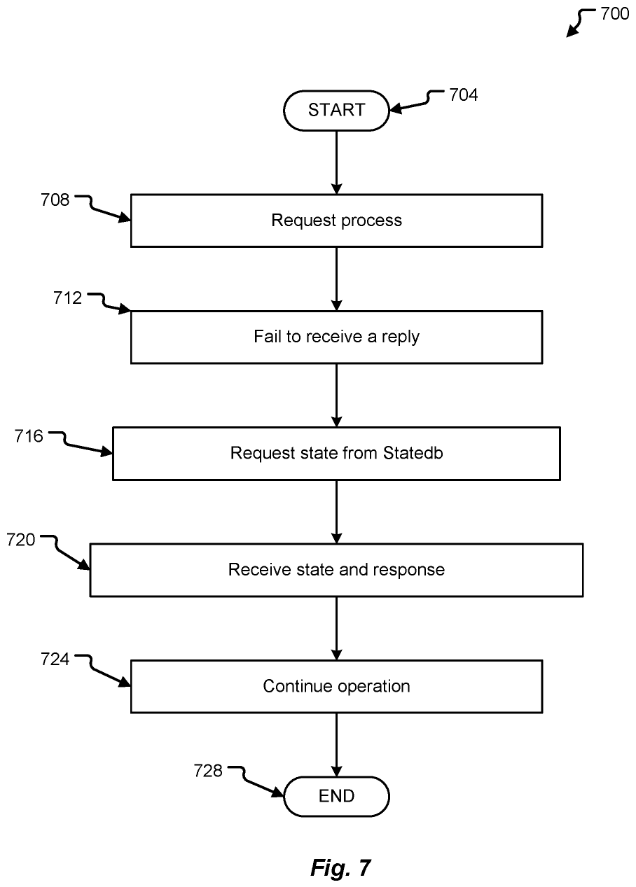

An example of a method 700 for communicating a change in the state of a container process may be as shown in FIG. 7. A general order for the operations of the method 700 is shown in FIG. 7. Generally, the method 700 starts with a start operation 704 and ends with an end operation 728. The method 700 can include more or fewer operations or can arrange the order of the operations differently than those shown in FIG. 7. The method 700 can be executed as a set of computer-executable instructions executed by a routing system 112 and encoded or stored on a computer readable medium. Further, the method 700 can be performed by gates or circuits associated with a processor, an ASIC, a FPGA, a SOC, or other hardware device. Hereinafter, the method 700 shall be explained with reference to the systems, components, devices, modules, software, signals, data structures, interfaces, methods, etc. described in conjunction with FIGS. 1-6; however, it will be understood by those of skill in the art that some or all of the operations of method 700 can be performed by or using different elements from those described below.

The forwarding arbiter 306 can receive a request for a process, in operation 708. The request can come from the control process 302 or from another process. This request for the process may then be forwarded to the container 320. For example, forwarding arbiter 306 can resend a request or instruction message to the BGP 310. After some period of time, the request may timeout. For example, if the container 320 is in a failure state, the software is upgrading, or for some other reason is not available to respond to the message, that request may timeout. In other circumstances, the container or other process can send a redirect message data structure 512 to the forwarding arbiter 306 instructing the forwarding arbiter 306 to request the state from the statedb 308. Thus, the forwarding arbiter 306 may fail to receive a reply, in operation 712.

Upon failing to receive the reply from the unavailable process, forwarding arbiter 306 can request the state from the statedb 308, in operation 716. The forwarding arbiter 306 can send a message to the statedb 308 to determine the state of the unavailable process. The statedb 308 can read the container state 530 and the response 532, from the data structure 528, and provide that information in the wait message data structure 520. Thus, this forwarding arbiter 306 can receive the state of the process in this wait message data structure 520, in operation 720. Any information about the container state 530 or response 532 may be included in the wait message 522. This information informs the forwarding arbiter 306 of the status of the unavailable container 320 and how to adjust or address the unavailability of that process.

The forwarding arbiter 306 and the other processes 312 to 316, for example, may continue to operate, in operation 724. Here, the various processes in the software architecture 300 of the routing system 112 can still function even while the one or more containers being unavailable.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or operations to those claimed, whether or not such alternate, interchangeable and/or equivalent structures, functions, ranges, or operations are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

An aspect of the present disclosure can comprise a method comprising: requesting functionality from a routing process executed by a router; failing to receive a reply to the request for functionality from the requested routing process; in response to failing to receive the reply, requesting a state of the routing process from a state database (statedb); receiving the state of the routing process from the statedb; and continuing operation regardless of the state of the routing process.

Any of the one or more above aspects may further comprise, wherein the routing process is in a container.

Any of the one or more above aspects may further comprise, wherein the routing process is unavailable.

Any of the one or more above aspects may further comprise, wherein the routing process is unavailable due to software associated with the routing process being upgraded or changed.

Any of the one or more above aspects may further comprise, wherein a forwarding arbiter requests the functionality from the routing process and requests the state from the statedb.

Any of the one or more above aspects may further comprise, wherein the forwarding arbiter receives the state in a wait message that indicates an amount of time to wait for the routing process.

Any of the one or more above aspects may further comprise, further comprising: the container sending a stop message before becoming unavailable, wherein the stop message provides information about the unavailability of the container.

Any of the one or more above aspects may further comprise, wherein the statedb changes the state of the routing process again after the routing process, in the container, restarts.

Any of the one or more above aspects may further comprise, wherein a second routing process continues to function while the routing process is upgraded.

Another aspect of the present disclosure can comprise a control component comprising: a memory to store one or more of instructions and data; a processor, in communication with the memory, wherein the instructions cause the processor to execute a method, the method comprising: a container, containing a routing process, sending a stop message that indicates the routing process will be unavailable; a forwarding arbiter receiving the stop message; the forwarding arbiter receiving a request for the container; in response to the forwarding arbiter receiving the request for the container, the forwarding arbiter requesting a state of the container from a state database (statedb); and the forwarding arbiter continuing to execute while the container is unavailable.

Any of the one or more above aspects may further comprise, wherein the stop message instructs the forwarding arbiter to check with the statedb for the state of the container.

Any of the one or more above aspects may further comprise, wherein the statedb also receives the stop message and changes the state of the container.

Any of the one or more above aspects may further comprise, wherein an adjacent process also receives the stop message and pauses in response to the stop message.

Any of the one or more above aspects may further comprise, wherein the statedb provides the state and other information associated with the unavailability of the container in response to the request from the forwarding arbiter.

Another aspect of the present disclosure can comprise a routing system comprising: a routing component, comprising: an interface to route data; and a control process in communication with the interface, the control process to: request functionality from a control component, the functionality associated with a first routing process executing on the control component; a control component in communication with the routing component, the control component comprising: one or more containers having a routing process contained therein; a state database (statedb), in communication with the one or more containers, the statedb to store a state of the one or more containers; a forwarding arbiter, in communication with the one or more containers and the statedb, the forwarding arbiter to: receive the request for functionality from the first routing process, wherein the first routing process is associated with a first container of the one or more containers; in response to receiving the request for functionality, request the functionality from the first container; fail to receive a response to the request to the first container; in response to failing to receive the response to the request to the first container, send a state request to the statedb to obtain a first state of the first container from the statedb; receive a wait message, associated with the first container, from the statedb; and instruct the control process to wait for the functionality associated with the first routing process, wherein the control process continues to execute while waiting for the first routing process.

Any of the one or more above aspects may further comprise, wherein the forwarding arbiter further receives a stop message from the first container, wherein the stop message instructs the forwarding arbiter to check with the statedb for the first state of the first container.

Any of the one or more above aspects may further comprise, wherein the statedb also receives the stop message and changes the first state of the first container.

Any of the one or more above aspects may further comprise, wherein the wait message includes the first state and other information associated with unavailability of the first container in response to the state request from the forwarding arbiter.

Any of the one or more above aspects may further comprise, wherein the first container is unavailable as the first routing process associated with the first container is being upgraded.

Any of the one or more above aspects may further comprise, wherein the forwarding arbiter indicates to the control process an amount of time to wait for the first routing process.

A means of or for any of the one or more above aspects.

Any of the one or more above aspects may be combined with any of the other one or more above aspects.

What is claimed is:

1. A method comprising:
requesting functionality from a routing process executed by a router;
failing to receive a reply to the request for functionality from the requested routing process;
in response to failing to receive the reply, requesting a state of the routing process from a state database (statedb);
receiving the state of the routing process from the statedb; and
continuing operation of at least a second routing process regardless of the state of the routing process.

2. The method of claim 1, wherein the routing process is in a container.

3. The method of claim 2, wherein the routing process is unavailable.

4. The method of claim 3, wherein the routing process is unavailable due to software associated with the routing process being upgraded or changed.

5. The method of claim 4, wherein a forwarding arbiter requests the functionality from the routing process and requests the state from the statedb.

6. The method of claim 5, wherein the forwarding arbiter receives the state in a wait message that indicates an amount of time to wait for the routing process.

7. The method of claim 6, further comprising: the container sending a stop message before becoming unavailable, wherein the stop message provides information about the unavailability of the container.

8. The method of claim 7, wherein the statedb changes the state of the routing process again after the routing process, in the container, restarts.

9. The method of claim 8, wherein the second routing process continues to function, in a second container, while the routing process is upgraded.

10. A control component comprising:
a memory to store one or more of instructions and data;
a processor, in communication with the memory, wherein the instructions cause the processor to execute a method, the method comprising:
a container, containing a routing process, sending a stop message that indicates the routing process will be unavailable;
a forwarding arbiter receiving a request for the container;
in response to the forwarding arbiter receiving the request, the forwarding arbiter forwarding the request to the container;
in response to the forwarding arbiter forwarding the request to the container, the forwarding arbiter requesting a state of the container from a state database (statedb); and
the forwarding arbiter continuing to execute while the container is unavailable.

11. The control component of claim 10, further comprising: the forwarding arbiter receiving the stop message in response to forwarding the request to the container, wherein the stop message instructs the forwarding arbiter to check with the statedb for the state of the container.

12. The control component of claim 10, wherein the statedb also receives the stop message and changes the state of the container.

13. The control component of claim 10, wherein an adjacent process also receives the stop message and pauses in response to the stop message.

14. The control component of claim 10, wherein the statedb provides the state and other information associated with the unavailability of the container in response to the request from the forwarding arbiter.

15. A routing system comprising:
a routing component, comprising:
an interface to route data; and
a control process in communication with the interface, the control process to:
request functionality from a control component, the functionality associated with a first routing process executing on the control component;
a control component in communication with the routing component, the control component comprising:
one or more containers having a routing process contained therein;
a state database (statedb), in communication with the one or more containers, the statedb to store a state of the one or more containers;
a forwarding arbiter, in communication with the one or more containers and the statedb, the forwarding arbiter to:
receive the request for functionality from the first routing process, wherein the first routing process is associated with a first container of the one or more containers;
in response to receiving the request for functionality, request the functionality from the first container;
fail to receive a response to the request to the first container;
in response to failing to receive the response to the request to the first container, send a state request to the statedb to obtain a first state of the first container from the statedb;
receive a wait message, associated with the first container, from the statedb; and
instruct the control process to wait for the functionality associated with the first routing process, wherein the control process continues to execute while waiting for the first routing process.

16. The routing system of claim 15, wherein the forwarding arbiter further receives a stop message from the first container, wherein the stop message instructs the forwarding arbiter to check with the statedb for the first state of the first container.

17. The routing system of claim 16, wherein the statedb also receives the stop message and changes the first state of the first container.

18. The routing system of claim 17, wherein the wait message includes the first state and other information associated with unavailability of the first container in response to the state request from the forwarding arbiter.

19. The routing system of claim 18, wherein the first container is unavailable as the first routing process associated with the first container is being upgraded.

20. The routing system of claim 19, wherein the forwarding arbiter indicates to the control process an amount of time to wait for the first routing process.
